(19) United States
(12) Patent Application Publication
(10) Pub. No.: US 2013/0051413 A1
(43) Pub. Date: Feb. 28, 2013

(54) INTERNALLY COOLED, THERMALLY CLOSED MODULAR LASER PACKAGE SYSTEM

(71) Applicants: Pei Chuang Chen, Monrovia, CA (US); Leming Wang, Monrovia, CA (US); Xin Simon Luo, Monrovia, CA (US)

(72) Inventors: Pei Chuang Chen, Monrovia, CA (US); Leming Wang, Monrovia, CA (US); Xin Simon Luo, Monrovia, CA (US)

(73) Assignee: AGX Technologies, Inc., Monrovia, CA (US)

(21) Appl. No.: 13/218,341

(22) Filed: Aug. 25, 2011

(51) Int. Cl. H01S 3/04

(52) U.S. Cl. 372/36

(57) ABSTRACT

An internal laser module may be capable of providing a similar high performance as that provided by traditional internally cooled laser modules, but with improved cost efficiency and manufacturability. In the internally cooled laser module, a laser subassembly, such as a coaxial semiconductor laser, may be mounted on a thermoelectric cooler cooler-base with several other components enclosed in a properly designed case.

### CROSS-REFERENCE TO RELATED APPLICATIONS

This application claims priority to and benefit of U.S. Provisional Application No. 61/337,059, filed Aug. 25, 2010, and entitled “INTERNALLY COOLED, THERMALLY CLOSED MODULAR LASER PACKAGE SYSTEM”, and hereby incorporated by reference.

### BACKGROUND OF THE INVENTION

Semiconductor lasers are widely used across a variety of applications. Performance of the semiconductor laser is affected by variations in temperate. As ambient temperature varies, the optical and electronic parameters of a semiconductor laser would change and degrade the laser performance. To satisfy application conditions and requirements of operating over a wide temperature range, semiconductor lasers are usually packaged and categorized in three major types of cooling, namely uncooled, internally cooled, and externally cooled. In brief, an uncooled system includes a laser chip and optical parts mounted in the same case without a cooler device. One example of an uncooled system is a coaxial semiconductor laser. An externally cooled system includes a cooling device externally mounted outside a laser diode case. Moreover, an internally cooled system includes a laser diode chip, optical parts and a cooler device mounted inside the same case. An example of an internally cooled system is a metal butterfly laser.

As is known, uncooled laser packages do not contain any active cooling component.

Changes in lasing properties such as wavelength, output power, electrical to optical power conversion efficiency, etc., are either ignored in the application, or compensated through electrical or optical feedback. An example of an uncooled laser package is the coaxial package, as illustrated by FIG. 2, where the laser chip 1 and monitor photodiode 2 are mounted in a transistor outline (TO) header 3, which is hermetically sealed with a lens cap 5. Lasing light is coupled into an optical fiber 9, or a fiber stub using the lens 6. The fiber coupling section is protected by a sleeve 7 and plastic tube 8. Since the TO header and lens cap are produced in high volume for CD and DVD lasers, this form factor is very low cost relative to the butterfly package. However, the laser chip temperature would change almost directly proportional to the ambient temperature varying.

For applications that require the laser to be operated under temperature control, it is possible to apply external cooling to an otherwise uncooled laser package. This type of external-cooled laser module has been in common practice in the industry or described by previous invention, as exemplified by U.S. Patent Publication No. 2007/0189677 by Murry et al., where a coaxial laser package is clamped inside a heat sink which is attached to an external TEC. External circuit boards is further connected to the coaxial laser to adapt to other footprints. However, externally cooled laser packages do not work as well over temperature as internally cooled packages. For example, butterfly laser packages can easily achieve 50° C. temperature differential between the laser chip and the ambient, compared to 30° C. or less for the traditional externally cooled laser packages, refer to curve 2 of FIG. 1. This configuration also results in the TEC operating with poor efficiency, and therefore consumes significantly more power than a butterfly laser package.

Typically, an internally cooled laser package allows a semiconductor laser diode chip to operate at a fixed temperature by automatic temperature control to compensate for ambient temperature changes. Usually, temperature control is accomplished by internal components such as a thermoelectric cooler (TEC) and a thermistor sensor operating under a feedback loop from an external powering circuit.

An example of an internally cooled laser package is a package commonly referred to as the 14-pin “butterfly package,” as illustrated in FIG. 3. The module includes a laser diode 1, a back monitor photodiode 2 and a thermistor 3, which are mounted on a thermally conductive submount 9, which in turn is soldered on the cold-side of a TEC 8. The coupling assembly of lens and optical isolator 7 for improved optical performance are also soldered on the same TEC 8 to keep the temperature constant with the laser chip. Electrical bias-T and radio frequency impedance matching circuits to facilitate separate DC and RF inputs to the laser diode may also be built into the module. Because the laser diode and monitor photodiode are subject to degradation if exposed to moisture, the butterfly package, with all its internal components, is typically hermetically sealed. Thus, the entire butterfly package body is made from metal and ceramic materials.

### SUMMARY OF THE INVENTION

In the present disclosure, an internal laser module is disclosed. The internal laser module may be capable of providing a similar high performance as that provided by traditional internally cooled laser modules, but with improved cost efficiency and manufacturability. In the exemplary internally cooled laser module, a laser subassembly, such as a coaxial semiconductor laser, may be mounted on a thermoelectric cooler (TEC) cooler-base with several other components enclosed in a properly designed case. The techniques and design principles are adapted to increase the thermal insulation and optoelectronic parameters in the internally cooled laser module in order to increase or maximize the stability of the laser's performance over a wide temperature dynamic range.

For a laser mounted with a TEC enclosed in a case, there are two primary thermal sources. The first major source is the heat energy generated by a laser chip, and the second major source is heat energy transferred onto the laser from an ambient thermal source, such as surrounding air. The former is directly proportional to laser biasing current, and the latter is proportional to the temperature difference between the laser and ambient environment, which is the force that drives thermal energy transfer onto the laser.

Generally, there are three major types of thermal energy transfer caused by an external ambient thermal source involved in the thermal stability occurring inside a thermoelectric cooled laser module. The three major types are 1) thermal conduction or diffusion, 2) convection, and 3) radiation. The thermal conduction process conducts the external thermal energy to the inner surface of the case, and then the inner surface heats up the surrounding air. This process may result in the convection of air or even directly radiate the thermal flux onto the laser module. The filling insulation medium in the inner space of the module may reduce these thermal processes happening. The medium with high thermal resistance can decrease convection effect and radiation meanwhile minimizing the thermal conduction happening. In the laser module, the thermal transfer would reach to a steady state when the total thermal energy appeared on laser component including the flow-in thermal energy from ambient source (like air) and that generated by laser biasing current is equal to the amount extracted and dissipated by TEC per unit time The ratio of the flow-in thermal energy per unit-time to that of extracted and dissipated thermal energy per unit-time by TEC cooler may indicate how high the temperature difference in between the laser chip and the ambience. The higher the ratio, the higher ambient temperature a laser can work well in. In this invention, several new techniques and methods are described which provide novel low-cost external-cooled laser modules with comparable high thermal stability of traditional high cost metal butterfly laser modules.

With respect to cost comparisons, internally cooled packages are the most expensive, followed by externally cooled packages, whereas uncooled packages are generally of lowest cost. The various embodiments described herein provide low-cost, internally cooled semiconductor laser package systems which incorporate efficient thermal management and excellent radio frequency signal transfer between external bias circuitry and the laser diode. Exemplary package systems comprise a thermally closed case, an optical coupling subsystem, a heat sink positioned optimally near the heat source, a thermal sensor, a thermoelectric cooler and bias circuitry. This combination features low power consumption while maintaining constant working temperature of the laser and results in significant energy savings. Moreover, radio frequency and optical performance may be further enhanced by conditioning elements in the bias circuitry.

### BRIEF DESCRIPTION OF THE DRAWINGS

A more complete understanding of the present invention may be derived by referring to the detailed description and claims when considered in connection with the Figures, and:

FIG. 1 illustrates a graph comparing cooling properties of prior art laser modules and an exemplary laser module;

FIG. 2 illustrates a prior art uncooled laser package;

FIG. 3 illustrates a prior art internally cooled butterfly laser package;

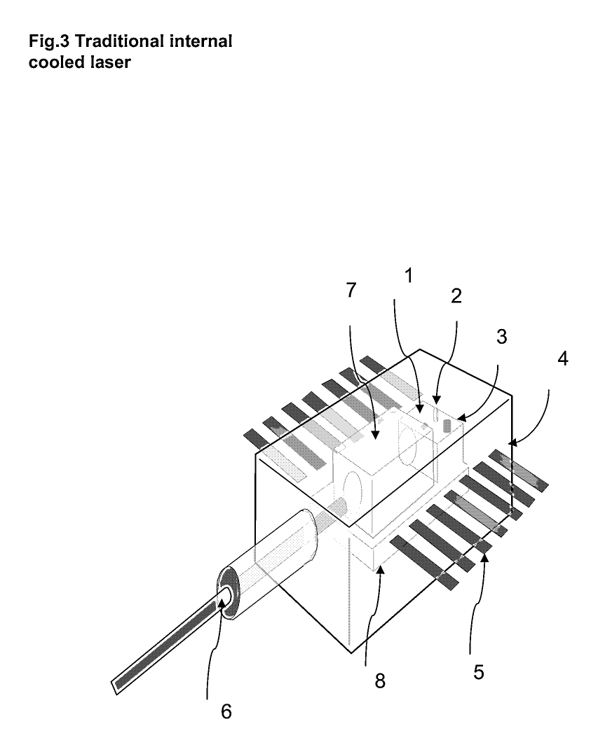

FIG. 4 illustrates an exploded view of an exemplary laser internally cooled laser package system;

FIG. 5 illustrates an exploded view of another exemplary laser internally cooled laser package system;

FIG. 6 illustrates an exemplary embodiment of a bisected bottom frame;

FIG. 7 illustrates an exploded view of an exemplary internal laser assembly;

FIG. 8 illustrates exemplary embodiments of circuit boards;

FIG. 9 illustrates exemplary embodiments of circuit boards with radio frequency connectors;

FIG. 10 illustrates an exploded view of an exemplary front radio frequency connection laser system case; and

FIG. 11 illustrates exemplary embodiments of angled brackets for use in an internally cooled laser package.

### DESCRIPTION OF PREFERRED EMBODIMENTS OF THE INVENTION

The present invention may be described herein in terms of various functional components and various processing steps. It should be appreciated that such functional components may be realized by any number of material or structural components configured to perform the specified functions. For example, the present invention may employ various components and materials which may be suitably configured for various intended purposes. However for purposes of illustration only, exemplary embodiments of the present invention will be described herein in connection with an internally cooled laser module.

The present disclosure relates to an apparatus and method using a compact and cost effective laser module compared to traditional internally cooled laser modules, such as metal butterfly laser modules. The laser module is configured to control and manage thermal insulation and conduction. An exemplary embodiment is directed to an internally cooled laser package system which may provide very stable performance at high temperatures.

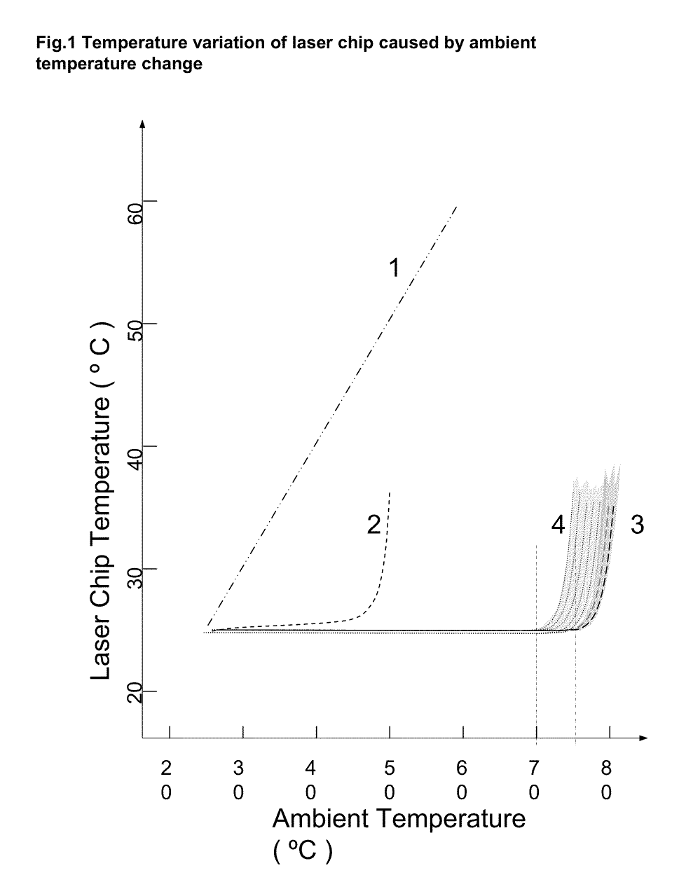

FIG. 1 illustrates the temperature variation of a typical laser chip following the change of the ambient temperature for four types of laser packages. In FIG. 1 (the temperature varying caused by laser biasing current is neglected temporally), curve 1 is for an uncooled laser module showing that the chip temperature increases rapidly with ambient temperature because the module has no temperature controlling capability at all. Curve 2 is a typical profile for the traditional external-cooled laser module, where the controlling capability of chip temperature is very limited and the maximum differential temperature range is about 20° C. with a reference working temperature of 25° C. Curve 3 shows very strong temperature stability of laser chip for the traditional metal butterfly type of internal-cooled laser module with the differential temperature range of about 50-55° C. Curve 4 is for the new, novel internal-cooled laser module based on the techniques described in this invention with typical differential temperature range of ˜45° C. Major differences of the temperature relationship among these types of laser modules are caused by the fundamental differences in the design and technologies of packaging a laser into a module.

An exemplary embodiment includes an integral case enclosure which houses an optical coupling subassembly, a thermoelectric cooler, a temperature sensor and electrical circuitry, resulting in thermal performance similar to that of the butterfly laser package.

In various exemplary embodiments, an internally cooled laser package system includes an internal optical coupling subsystem engaging a light source (such as a laser diode), coupling optics and optical fiber. The laser diode may be hermetically sealed inside a hermetic package such as a transistor outline header and cap. Other components inside the transistor outline header and cap may include a monitor photodiode and a thermal sensor. The cap may have a built in lens for coupling light from the laser into the optical fiber. The optical fiber extends out from the case and is terminated with an optical connector. An optical isolator may be placed in the path of the laser light before entering the fiber. The optical fiber may be of single or multimode. These parts can be similar to standalone uncooled laser products similar to those offered by others and the PLMR series from AGx Technologies, Inc.

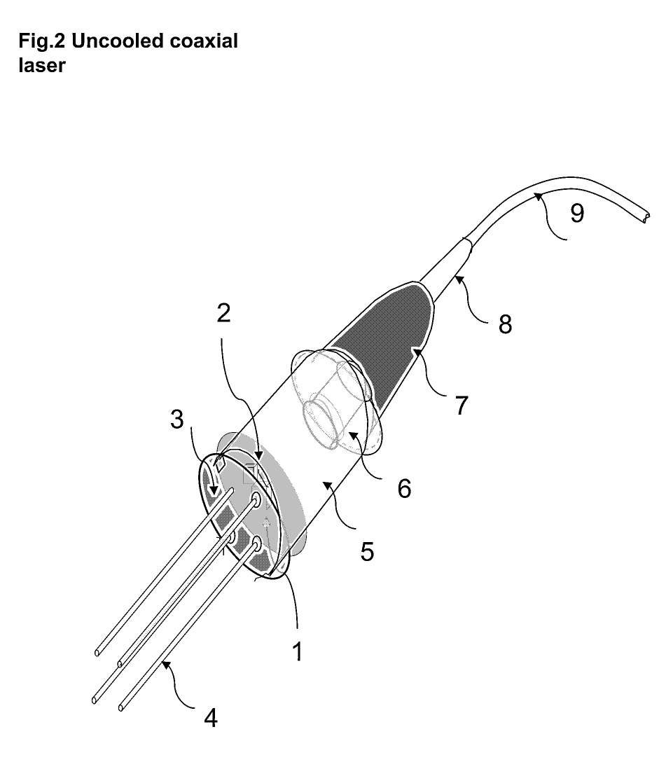

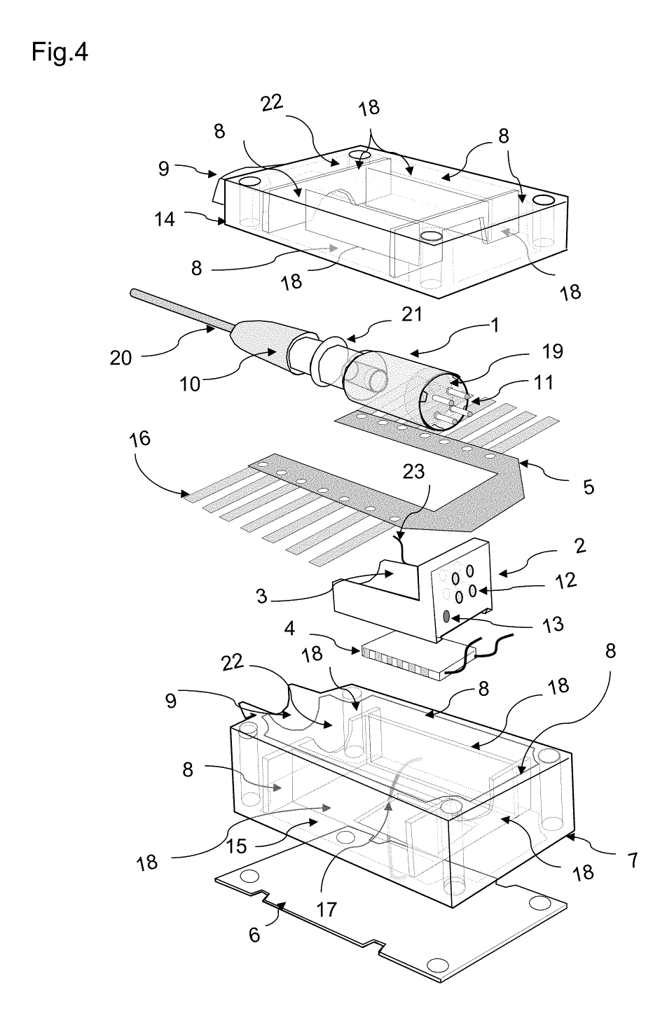

In accordance with an exemplary embodiment and with respect to FIG. 4, a laser subassembly 1 is similar to an uncooled laser package, and comprises an optical coupling component 10, a transistor outline (TO) header 19 with pins 11, a fiber-out end 20, and a stage 21. Additionally, laser subassembly 1 further comprises a laser chip and a monitor photodiode, similar to the components described with respect to FIG. 2. Although FIG. 4 shows four pins from laser subassembly 1, other embodiments of last subassembly 1 may use three pins or five pins.

In various exemplary embodiments, laser subassembly 1 may be mounted on an angled bracket 2 by a low melt-temperature solder and/or thermal-electrical-conductive epoxy. In contact with the bottom of angled bracket 2 is a thermal-electrical cooler (TEC) 4. In various embodiments, angled bracket 2 is designed to allow pins 11 from laser subassembly 1 to pass through the bracket. Angled bracket 2 may include holes for the pins or cut-out sections allowing the pins 11 to pass. Furthermore, angled bracket 12 may include a thermistor access point 13, where the thermistor access point 13 is designed to attach to a thermistor. A thermistor is a temperature-sensing element composed of sintered semiconductor material which exhibits a large change in resistance proportional to a small change in temperature. Furthermore, if a thermal sensor is not inside the TO header, one may be embedded or attached to the heat sink for effective temperature control under external feedback circuits.

The laser subassembly 1 may be driven and modulated through a circuit board 5 with the properly selected type of the four pins 11 coming through TO header 19 of laser subassembly 1. In an exemplary embodiment, angled bracket 2 comprises a contact surface 3 having a concave shape to match the case profile of laser subassembly 1. The concave shape provides structural support to laser assembly 1 and also increases the contact surface area between laser assembly 1 and angled bracket 2, which creates more effective heat conduction.

With continued reference to FIG. 4, TEC 4 may be located between the bottom of angled bracket 2 and a heat sink 6. The internally-equipped TEC usually automatically adjusts for heat dissipation according to the ambient temperature in order to maintain the laser chip operating at a specified constant temperature. Maintaining a constant operating temperature generally prevents the laser from thermally induced changes in lasing characteristics such as wavelength, output power, electrical to optical power conversion efficiency, and the like. Furthermore, a wire 23 may be used to provide proper grounding for TEC 4 for wideband applications.

The various embodiments include an integral case enclosure which serves to protect the internal components from the environment, and also functions as part of the thermal subsystem. The case may be built from any suitable materials, such as metal or plastic. For improved insulation against convective thermal transfer, soft and thermally insulating gaskets, such as those made from closed cell silicone foam, are used to seal the case. Alternatively, soft epoxy or adhesive can also be used as sealant for the case. This forms a closed thermal system which helps to provide the temperature performance necessary for temperature stabilized laser diode applications.

Moreover and with continued reference to FIG. 4, laser subassembly 1 and angled bracket 2 may be enclosed in a multi-piece case comprising a bottom frame 7, a top cap 14, and a heat sink plate 6. Heat sink plate 6 may be separate from bottom frame 7 and simply attached, or may be integrated into bottom frame 7. In an exemplary embodiment, the heat generated from the laser diode chip during operation is dissipated through the TO header. There, the heat is efficiently spread into a high thermal conductivity heat sink attached to the base of the TO header. The heat sink material can be either composed of high thermal conductivity ceramics such as aluminum nitride, or high thermal conductivity metals such as copper, copper tungsten, brass, bronze, or other suitable metals. This configuration results in a low thermal resistance between the laser and heat sink.

In various embodiments, the optical subsystem is laid horizontally with the optical fiber pointing sideways to keep the laser package low in profile. A TEC 4 is configured horizontally below the optical sub-system to extract heat in the vertical direction. The angled bracket 2 transfers the heat primarily from the base of the optical subsystem to the top plate of the TEC 4. Epoxy or solder can be used to attach the angled bracket to the top plate of the TEC. The bottom side of the TEC may be attached by solder or epoxy to the high conductivity base plate 6 of the case.

An exemplary embodiment includes heat sink plate 6 made of high thermal conductivity metals (such as copper, copper tungsten, brass, bronze, or other suitable metals) and forming the base of the enclosed case. The case and the metal heat sink plate 6, in various embodiments the laser package, may be thermally connected to an external heat sink. In this embodiment, pressure is applied to the base plate to keep this interface efficient at heat transfer. Holes (or other suitable structures) may be present on the base plate 6 to facilitate mounting the base plate onto the user's equipment external heat sink with screws. The screw mount holes may be on the case as well. Mechanically, the case is preferably cushioned against the internal optical coupling subsystem while applying pressure to the base plate to prevent bending forces on the sensitive optics of the optical coupling subsystem. In one embodiment, a thermal pad is located between the base plate and the external heat sink. The thermal pad may provide the cushioning to prevent bending forces when sealing the case.

In various embodiments, specially designed built-in cavities and holes with/without filling proper insulation materials are properly adapted to minimize the possible thermal conduction and convection process. The specially designed built-in edges and stages in the case minimize, or substantially decrease, the external thermal energy flowing inside the case. In various embodiments, bottom frame 7 and top cap 14 comprise several cavities 8 and 22, which are formed by middle walls 18 and the side walls of bottom frame 7 or top cap 14. The cavities 8 and 22 may be used to hold a thermal resistant medium. Next to the thermal resistant medium, the gaps between the uncooled laser case and the walls 18 are filled with air as a second layer of thermal insulation. Furthermore, a cylindrical cavity formed by two half-cylinder walls 9 of bottom frame 7 and top cap 14 are designed to partially cover optical coupling component 10 in laser subassembly's fiber-out end 20. Additionally, an inner cavity 22 may be filled with a thermal medium to seal the fiber-out space of the case. In bottom frame 7, a window opening 15 is formed in the bottom part for attaching the hot side of TEC 4 to heat sink 6. In various embodiments, an edge 17 of window opening 15 is inclined to block the thermal flux flowing up from heat sink 6 back into the case.

In an internally cooled laser module, the proper direction and intensity of current going through the elements of TEC 4 controls the cooling of the laser module. The transfer the heat, which includes the heat produced by a working laser chip and thermal energy flow-onto the laser from outside the sealing case, may occur by passing the heat down to the bottom “hot” side of TEC 4. In various embodiments, TEC 4 is in contact with heat sink 6, which dissipates the heat by transferring into the ambient environment. In various methods, adjustment of the current through TEC 4 changes the amount of heat transferred from the laser chip and other parts of laser assembly 1. The adjustment of current may be automatically done by a feedback controlling loop, in which the thermistor compares the laser chip temperature to a set point temperature. The thermistor generates a corresponding difference voltage that is sent to a controllable DC current source. The DC current source may be configured to respond by driving a suitable current through the thermal coupler elements of TEC 4. In various embodiments, it is desirable for a laser module with TEC controlling system to work well in the range of ambient temperature from about −20° C. to about +75° C. while maintaining a laser chip temperature at around 25-35° C. The typical relationship between the temperatures of laser chip and the ambient is denoted by the curve 3 in FIG. 1.

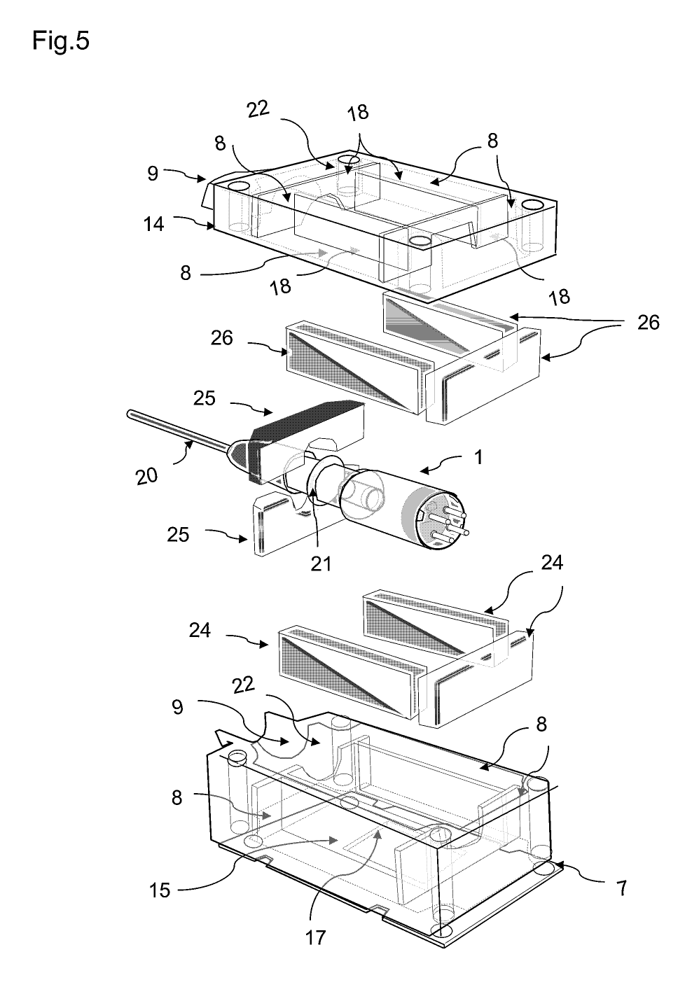

In the embodiment, in addition to the usage of thermal insulation materials, gaps, cavities and pockets of air are purposely included to maximize the efficiency of overall the thermal insulation. Further description of the thermal insulation based on this disclosure is illustrated in FIG. 5. In an exemplary embodiment, properly selected thermal mediums 24 and 26 fill the cavity 8 in bottom frame 7 and top cap 14. To obtain maximum, or substantially increased, thermal insulation based on this invention, the width ratio of the thermal medium to the cavities filled with air is in the range of 1:1 to 2:1. The thermal medium may be made from Silicone foam or other low thermal conductivity materials, with values of thermal conductivity less than 0.4 W/(M*K). In various embodiments, the two half pieces of the thermal insulation medium 25 form a circular hole and fill the cavity 22 to block thermal energy from exchanging through the fiber-out space of the case. The position of the cavity 22 is designed to contain stage 21 of laser subassembly 1 to increase the thermal distance by adding the extra-detour path.

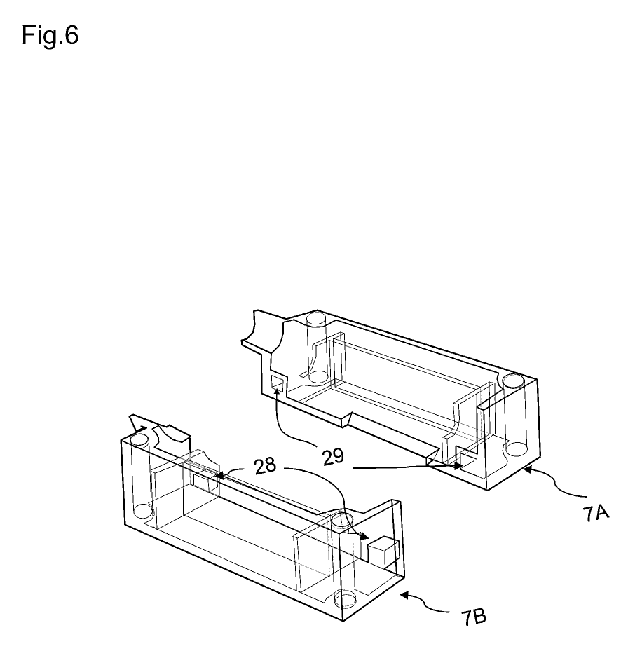

FIG. 6 illustrates a further embodiment with different designs of the bottom frame. The two components 7A and 7B with proper lock-pins 28 and the holes 29 form a complete bottom frame 7. The bisected design facilitates easier assembly of all components shown of the internally cooled laser package system. In other embodiments, it is also contemplated using a single piece forming the complete bottom frame 7.

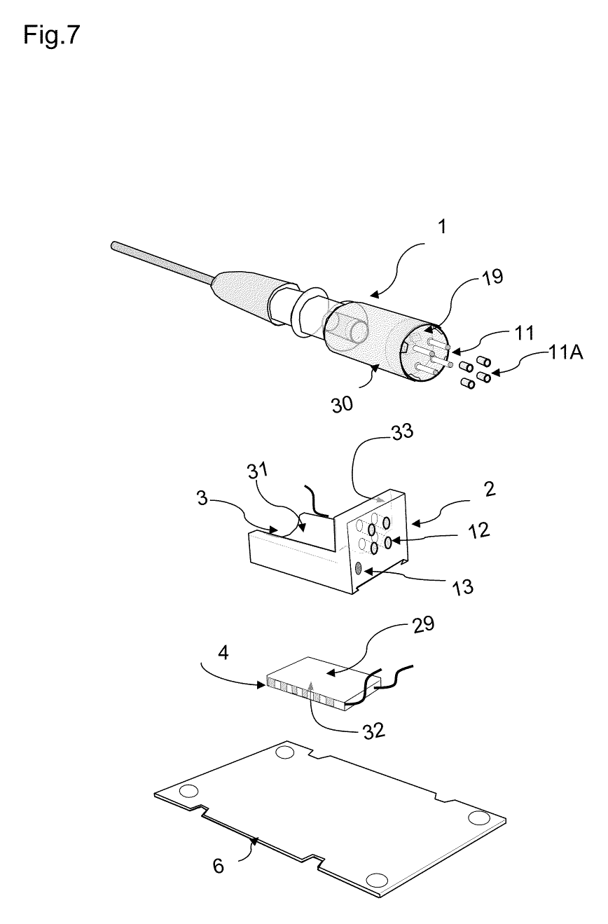

According to various exemplary embodiments and with reference to FIG. 7, a laser subassembly 1 is mounted on an angled bracket 2 using low melting-temperature solder and/or the properly selected thermal and electrical-conductive epoxy to connect the cylindrical surface 30 and the TO header bottom surface 19 to the matching surfaces 31 and 33 of angled bracket 2. Angled bracket 2 may be made from materials with good thermal conductivity, such as copper, copper-tungsten, brass, bronze or ceramics such as aluminum nitride, or other suitable materials. In order to prevent electrical contact of metal pins 11 with metal angled bracket 2, insulator sleeves 11A are used to cover pins 11. With proper selection of dielectric constant and size, good RF characteristics are preserved even with long lengths of pin 11. Furthermore, insulator sleeves 11A may be configured to provide structural support to pins 11 and provide flexibility by having some elasticity to the material. In various embodiments, sizes of holes 12 range from about 0.5-2 mm, cylindrical sleeve 30 may range from about 0.25-1.0 mm, and dielectric constant of insulator sleeves 11A may range from about 2.8-4.5. In various embodiments, the cold surface 29 of TEC 4 and the hot surface 32 of TEC 4 may be attached onto the bottom surface of angled bracket 2 and onto heat sink plate 6 respectively by low-melting temperature solder or thermal conductive epoxy.

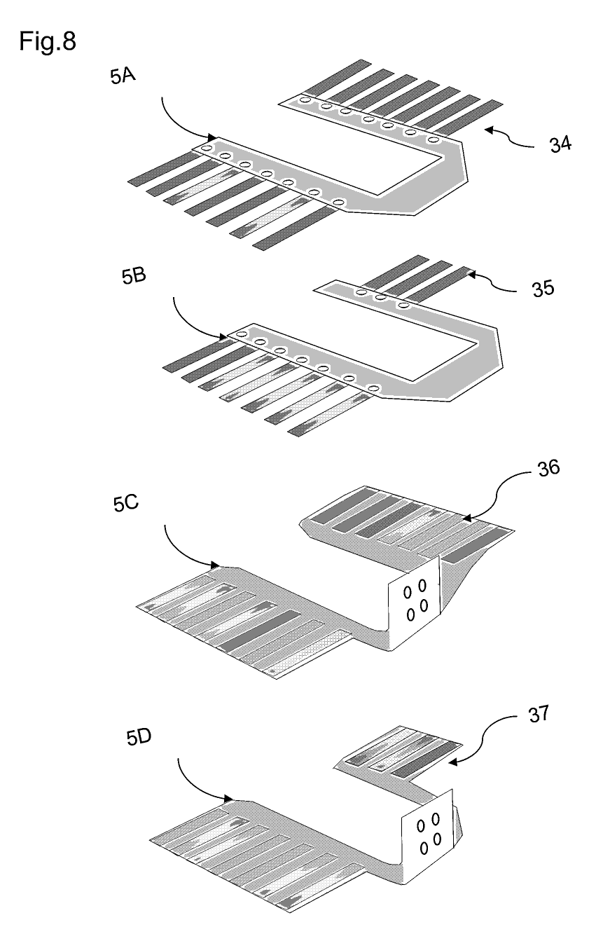

FIG. 8 illustrates the further embodiments with various types of pin-in and pin-out design according this disclosure. For example, a circuit board 5A has a regular 14 pin design 34, a circuit board 5B has a 10 pin design 35; a circuit board 5C has a 14 pin flex design 36, and a circuit board 5D has a 10 pin flex design 37. In flex circuit designs 5C and 5D, a non-conducting polyimide tracer is attached to both sets of flex pins in order to provide structural stability and make assembly easier. Other configurations that accomplish similar connections for other pin-outs are also possible as would be known to one skilled in the art.

The embodiments of the present disclosure may include an internal board that incorporates a bias, modulation and RF circuitry carrying signals to separate leads. Various forms of leads, wide-band connectors and/or straight pin; PCB and flex circuits, such as SMB, SSMB, SMA, mini BNC, GPO, straight pin, coplanar strip-line, etc. can be used in combination as input and output, connecting to the internal circuit board of our package system. They can be configured in a very flexible manner because of the internal board. Unlike traditional butterfly laser packages, where the laser diode chip needs to be kept in an extremely clean environment, there is no restriction to the type and material composition of the circuit board and components internal to the laser package system in accordance with the present invention, allowing a great deal of flexibility to include additional conditioning circuitry internal to the package system of the present invention.

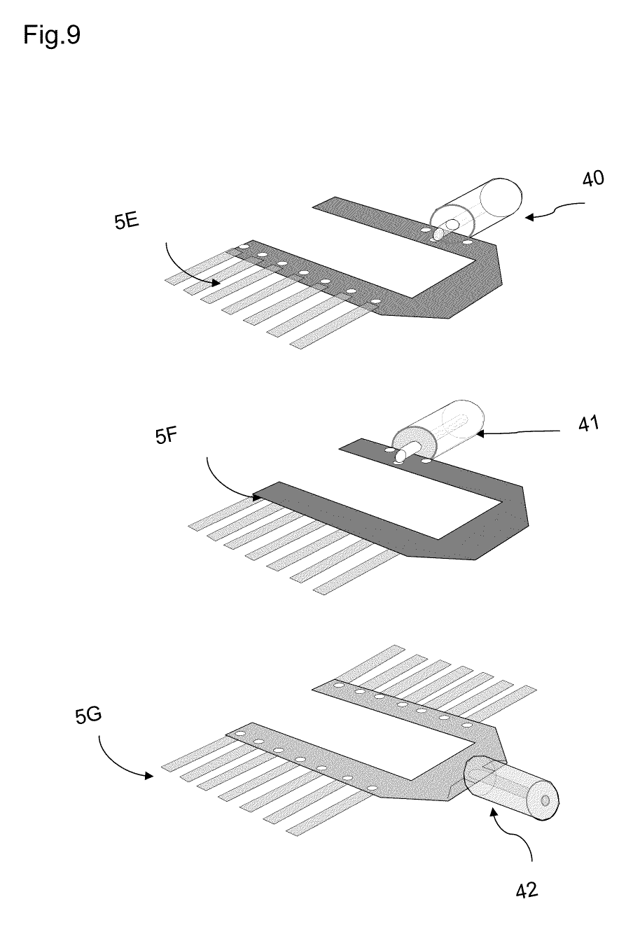

In various embodiments and with respect to FIG. 9, various types of pin-RF connector designs are possible for use in higher frequency applications. In circuit board designs 5E and 5F, a 7 pin circuit board comprises an RF connector 40, 41 at different positions dependant on the application requirement. The RF connectors 40, 41 may transmit high frequencies, whereas the remaining pins may be DC leads. Design 5E creates a shorter RF traveling distance from RF connector 40 and thereby provides better transmission properties than circuit board design 5F. However, circuit board design 5F is designed as a replacement for the traditional internal cooled laser modules because it adapts the same traditional pin assignment and layout. For some applications requiring very wideband transmission or special modulation, a circuit board design 5G with RF connector 42 on the end-side of the circuit board is shown. The RF connectors 40, 41, 42 according to this disclosure may be, but are not limited to, SMA, SMB, SSMB or GPO, K-connector. For the purpose of illustration, a circuit board is shown with 14 pins, but can be of other number of pins and configurations as would be known to one skilled in the art.

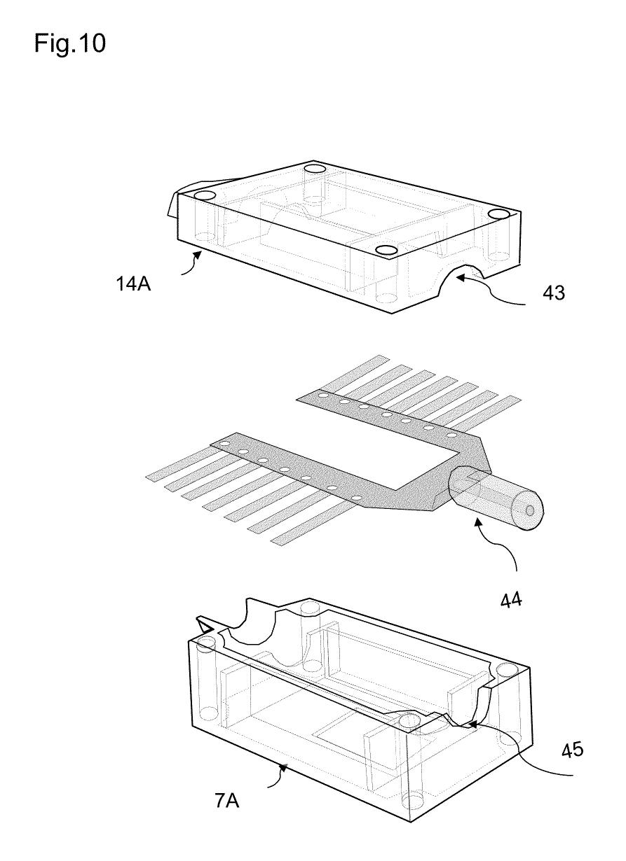

FIG. 10 illustrates the further exemplary embodiment of a bottom frame 7A and a top cap 14A of the case with end-side RF connection. The circular openings 43 and 45 form a hole to match the RF connector 44 located at the end side of the circuit board.

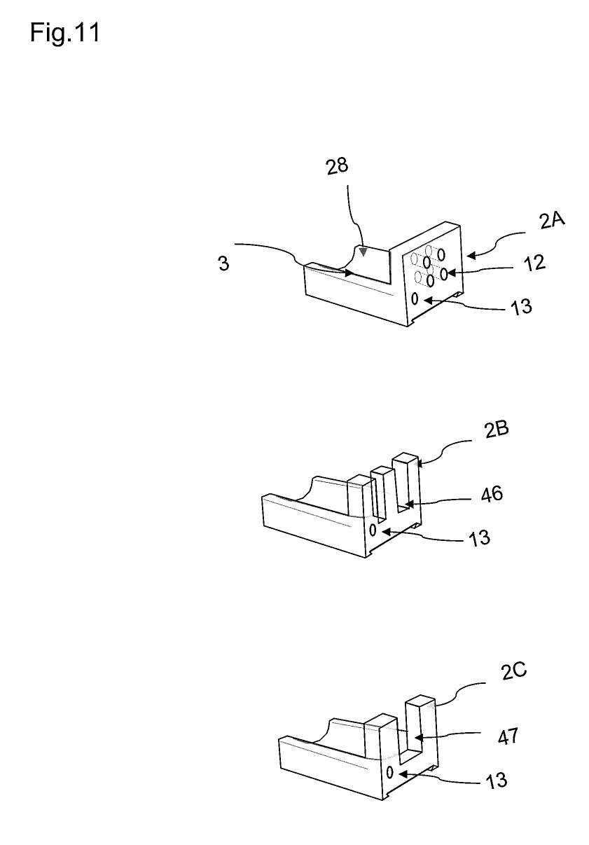

Furthermore, in various embodiments and with respect to FIG. 11, various types of the angled brackets may be used. Three various embodiments are illustrated, a first embodiment 2A being an angled bracket with holes cut-out 12 as was previously described. The two different designs for the angled bracket replace the four holes with cut-out openings. The second embodiment 2B illustrates an angled bracket with two cut-openings 46, whereas the third embodiment 2C illustrates an angled bracket with a single, larger cut-opening 47. In the various cut-opening embodiments, extra thermal material may be added to the thermal connective path to improve assembly efficiency without reducing thermal energy extraction.

In the embodiment, use of metallic heat sinks still preserves good RF signal transferring characteristics. To solve the grounding issue of a non-metal enclosure, our invention incorporate properly grounding method in the heat sink to reduce possible RF interference, larger return loss or impedance mismatching issue caused by stray capacitance and inductance of TEC and the pins of the TO header. A combination of properly dimensioned through holes in the bracket and choice of insulating sleeves prevents losses to high frequency RF signals as they travel in the pins. Good RF response can be maintained well beyond 6 GHz.

In operation, embodiments of the present invention help keep the laser chip operating at constant temperature while drawing similar TEC current compared to that of a butterfly laser, and significantly less than that of an externally cooled device. Hence this invention attains comparable thermal and RF performance but at a significantly lower cost. Compared to an externally cooled laser, this invention results in significant energy savings at a similar cost.

The particular implementations shown and described above are illustrative of the various exemplary embodiments and the best mode and are not intended to otherwise limit the scope of the present invention in any way. Changes or modifications may be made to the disclosed embodiment without departing from the scope of the present invention. These and other changes or modifications are intended to be included within the scope of the present invention, as expressed in the following claims. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A laser package system comprising:
a case including a plurality of through-holes, wherein each through-hole allows passage of a respective pin of an internal optical coupling subsystem enclosed within the case;
an internal circuit board;
a plurality of insulators, each of the plurality of insulators configured for thermally sealing a respective one of the plurality of through-holes.

2. The laser package system of claim 1, the case comprising an assembly of a plurality of pieces.

3. The laser package system of claim 2, wherein the plurality of pieces is formed from a non-electrically conducting and thermally-insulating and hard material.

4. The laser package system of claim 3, wherein the plurality of pieces further comprises a plurality of built-in cavities, edges, and holes.

5. The laser package system of claim 1, further comprising a heat sink, wherein the bottom of the case is attached to the heat sink.

6. The laser package system of claim 1, wherein each of the plurality of insulators is formed from a soft, non-electrically conducting and thermally-insulating material.

7. The laser package system of claim 1, wherein the internal optical coupling system comprising a laser diode, coupling optics, and optical fiber.

8. The laser package system of claim 7, wherein the laser diode is hermetically sealed inside a hermetic package, the hermetic package comprising a transistor outline (TO) header and a cap.

9. The laser package system of claim 8, further comprising one or more of a monitor photodiode and a thermal sensor sealed inside the hermetic package.

10. The laser package system of claim 8, wherein the cap includes a lens for coupling light from the laser into the fiber.

11. The laser package system of claim 8, further comprising a heat sink coupled to the TO header, wherein the TO header is configured to dissipate heat generated from the laser diode to the heat sink coupled to the TO header.

12. The laser package system of claim 8, further comprising:
a thermoelectric cooler (TEC) enclosed in the case; and
a heat sink coupled to the TEC.

13. A method for laser package system comprising a plurality of steps of:
manufacturing a case including a plurality of through-holes, each through-hole for allowing passage of a respective lead;
connecting a base coupled to the case;
connecting a plurality of insulators, each of the plurality of insulators for sealing a respective one of the plurality of through-holes;
mounting an internal optical coupling subsystem enclosed within the case; and
attaching an internal circuit board.

14. The method of claim 13, wherein the assembled case comprises a plurality of built-in cavities, edges, stages and holes.

15. The method of claim 13, further comprising a plurality of steps to assembly, wherein the internal optical coupling system comprises a laser diode, coupling optics, and optical fiber.

16. The method of claim 15, further comprising a plurality of steps to enclose, wherein the laser diode is hermetically sealed inside a hermetic package, and wherein the hermetic package comprises a transistor outline (TO) header and a cap.

17. The method of claim 16, further comprising a plurality of steps to mount, wherein the cap includes a lens for coupling light from the laser into the fiber.

18. The method of claim 16, further comprising a plurality of steps to engage a heat sink coupled to the TO header, wherein the TO header is configured to dissipate heat generated from the laser diode to a heat sink coupled to the TO header.

19. The method of claim 15, further comprising a plurality of steps to engage:
a thermoelectric cooler (TEC) enclosed in the case; and
a heat sink coupled to the TEC.

20. The method of claim 15, further comprising a plurality steps to configure and engage wherein the through-holes to accept leads from a plurality of wide-band connectors or straight pins.
